(19) United States
(12) Patent Application Publication
(10) Pub. No.: US 2026/0326573 A1
(43) Pub. Date: Oct. 22, 2026

(54) A SYSTEM AND A METHOD FOR CONTROLLING/REGULATING AN ELECTRICAL DEVICE THERMALLY COUPLED TO A COOLING SYSTEM FOR IMPROVING A DERATING

(71) Applicant: Robert Bosch GmbH, Stuttgart (DE)

(72) Inventor: Christian Dullinger, St. Pölten (AT)

(21) Appl. No.: 19/110,524

(22) PCT Filed: Sep. 19, 2023
(86) PCT No.: PCT/EP2023/075842

§ 371 Date: Mar. 11, 2025

(30) Foreign Application Priority Data
Sep. 22, 2022 (DE) 10 2022 210 005.0

(51) Int. Cl. B60L 3/12; B60K 11/02; B60L 3/00; B60L 58/24; B60L 58/32

(52) U.S. Cl. CPC B60L 3/12; B60K 11/02; B60L 3/003; B60L 3/0046; B60L 3/0053; B60L 58/24; B60L 58/32; B60L 2240/445; B60L 2240/525; B60L 2240/526; B60L 2240/545; B60L 2260/42

(57) ABSTRACT

A system for controlling an electrical device thermally coupled to a cooling system is proposed, comprising at least one temperature input for sensing at least one temperature of a coolant flowing into or out of the electrical device and/or a temperature of the electrical device, a control signal output, a storage unit, which is configured to store and output at least one characteristic variable of the electrical device, and a control unit connected to the at least one temperature input, the memory unit and the control signal output, wherein the control unit is configured to consider the current operating conditions of the electrical device from at least one temperature sensed at the at least one temperature input and to determine a dynamic model of an electrical target variable of the electrical device based on the at least one characteristic variable and signals of measured/calculated variables that take the current operating conditions of the electrical device into consideration, which is required to adjust a desired path of the temperature change rate and/or a desired temperature profile of the coolant or the device, and wherein the control unit is configured to output the at least one determined electrical target variable at the control signal output for activating the electrical device.

### BACKGROUND

The present invention relates to a system and a method for controlling/regulating an electrical device thermally coupled to a cooling system.

Cooling systems for cooling electrical devices, for example, a fuel cell stack, a drive battery, an engine, an inverter, and the like, must ensure that the power dissipation of the cooled device in the cooling circuit does not lead to overheating of the device. Consequently, it must be ensured that the device is operated within a designated temperature operating range to prevent a hazard or damage to the device or to persons using the device. If the cooling power of the cooling system is no longer sufficient to prevent overheating of the device, for example because the cooling system is has already been operating for some time at its maximum cooling power or due to a malfunction, a so-called derating of the (electrical) power of the device must be carried out in order to reduce the power dissipation of the device, which accumulates as heat in the device.

One such derating approach according to the prior art is to set the maximum allowable electrical power level or, depending on the desired implementation, the electrical current or the voltage, to a certain value if a certain maximum temperature threshold is exceeded. This derating approach is often also applied as a staggered derating in which multiple temperature thresholds and the associated maximum allowable electrical power levels are defined. In addition, it is known to implement a temperature hysteresis to prevent repeated, in particular constant, increases and decreases of the maximum allowable electrical power level if the temperature fluctuates around the threshold for the maximum allowable temperature.

However, such previously known derating approaches based on single or multiple temperature thresholds, with or without the use of a temperature hysteresis, do not result in a smooth derating, i.e., a smooth reduction in the power level, as they reduce the power level abruptly or suddenly depending on whether the threshold is exceeded or not. This behavior is often undesirable. This may be, for example, because the driver of a vehicle in which the engine or the like is subjected to such a derating approach experiences a sudden decline in power that can lead to surprising and thus highly undesirable driving situations.

As these derating approaches do not take into account the dynamic behavior of the cooled device by means of a dynamic physical model of the cooled device, serious overshooting of the temperature may occur, which may result in damage to the cooled device. Moreover, the fact that a dynamic physical model of the cooled device is not used may easily result in too much or too little derating, which may also depend on the operating conditions of the overall system. Last but not least, a derating that is not based on a dynamic physical model of the cooled device requires an extensive series of tests on a test bench to find suitable electrical power limits for the predetermined temperature thresholds, wherein these tests additionally present the risk of damaging the device.

### SUMMARY

The object of the invention is therefore to design a cooling system or a system or a method of controlling/regulating a cooling system or device cooled by it, through which derating may be improved.

A system for controlling/regulating an electrical device thermally coupled to a cooling system is proposed, comprising at least one temperature input for sensing at least one temperature of a coolant flowing into or out of the electrical device and/or a temperature of the electrical device, a control signal output, a storage unit, which is configured to store and output at least one characteristic variable of the electrical device, and a control unit connected to the at least one temperature input, the memory unit and the control signal output, wherein the control unit is configured to consider the current operating conditions of the electrical device from at least one temperature sensed at the at least one temperature input and to determine a dynamic model of an electrical target variable of the electrical device based on the at least one characteristic variable and signals of measured/calculated variables that take the current operating conditions of the electrical device into consideration, which is required to adjust a desired path of the temperature change rate and/or a desired temperature profile of the coolant or the device, and wherein the control unit is configured to output the at least one determined electrical target variable at the control signal output for activating the electrical device.

A core of the invention is to take into account the dynamic behavior of the device to be cooled in a derating so that a smooth and possibly early initiation of a power reduction can occur and overshooting or excessive derating can be prevented, and the electrical device can always be operated close to an acceptable power limit. For this purpose, a dynamic model is used which describes the device to be cooled with sufficient precision for the purpose and which is dependent on at least one characteristic variable. The system is capable of determining the manner in which at least one electrical target variable limited to the maximum value should be influenced to carry out a desired, smooth derating, by means of the at least one characteristic variable and signals of measured/calculated variables that take into account the current operating conditions of the electrical device. The maximum value is calculated via the dynamic model.

The electrical device may be, as mentioned above, a fuel cell stack, a drive battery, an engine, an inverter, or another heat generating device that is cooled by the cooling system. The coolant may be a fluid flowing through a heat exchanger thermally coupled to the device, absorbing heat, and releasing it downstream from a heat delivery device. The fluid may be liquid, gaseous or multi-phase.

The at least one temperature input may be coupled to at least one temperature sensor upstream and/or downstream of said heat exchanger and configured to measure the temperature of the coolant and/or the temperature of the device. Further temperature sensors may be disposed in the cooling system, for example, at the coolant outlet of a heat delivery device connected to a temperature input. By coupling to the at least one temperature input, the system may record the at least one measured temperature for further processing. The at least one measured temperature may be transmitted via analog and/or digital signals.

The control signal output of the system is provided to output a control signal, which may then be transmitted to the device to be cooled to control it. The control signal is generated by the control unit.

The control unit is configured to simulate the corresponding device by a dynamic model. The simulation does not have to run continuously, but may also perform a calculation step at discrete times in order to enable an assessment of the dynamic behavior of the device at the respective times.

As the power dissipation of the device to be cooled must be compensated for by the cooling power, the control unit is configured according to the invention to determine an electrical target variable that directly influences the power dissipation, by which a desired progression of the temperature change rate and/or a desired temperature profile of the coolant or the device can be achieved with a corresponding behavior. Based on a dynamic physical model of the device to be cooled, it is preferably possible to consider all available information about the current operating conditions as input signals, to calculate a maximum allowable electrical power, which results in a smooth derating. A desired and/or maximum allowable temperature change rate and/or a desired and/or maximum allowable temperature profile may be set, for example. Generally, the control unit may achieve a trajectory planning, i.e., a tracking of the device to a desired path of the temperature change rate and/or a desired temperature profile, wherein flatness-based pilot control and/or follow-up control is preferably used for this purpose.

The advantages of the system according to the invention are that even derating of the electrical power of the device to be cooled is achieved. The derating approach addresses the relevant system variable, i.e. the temperature, directly. The dynamic physical model of the device to be cooled and controlled/regulated may take into account all available information about the current operating conditions as input signals. The dynamic model of the maximum allowable temperature rate of change of the device may also be calibrated in any manner to meet desired derating requirements. The derating may be based on a planned trajectory for the desired temperature, which may be calibrated to meet desired requirements. The derating behavior may also be simulated and coordinated in advance.

There are also conceivable applications of the system/method, for example the drying of a fuel cell, in which the electrical target variable is not limited or not only limited to a maximum value, i.e. the derating is not the focus, but rather to a minimum value. The minimum value to which the desired electrical target variable is limited can also be calculated via the dynamic model in which a minimum allowable temperature change rate and/or a minimum allowable temperature profile are set.

In one advantageous embodiment, the control unit is configured to reduce the at least one determined electrical target variable only when a variable calculated from the temperate input or inputs exceeds a predetermined threshold. The corresponding target variable is therefore not output until the threshold is exceeded. The predetermined threshold may be set to a fixed value or may be made dependent on one or more parameters and/or signals, for example, the ambient temperature. Until the threshold is reached, the electrical device to be cooled can consequently be operated or controlled normally.

In one advantageous embodiment, the control unit is configured to maintain the temperature of the coolant at a predetermined maximum temperature by activating the electrical device. The predetermined maximum temperature corresponds to a temperature at which the device to be cooled generates a power dissipation that is substantially equal to the maximum cooling capacity. The device may then be operated at a maximum power which can still be managed by the cooling system and which is to be held stationary.

In one advantageous embodiment, the control unit is configured to track and/or calibrate one or more of at least one simulated state variable and/or at least one simulated output variable by incrementally adjusting at least one function member of the dynamic model by at least one model error correction term to measured output variables of the device to be cooled. For example, a model error may be calculated by an estimator. In addition to the parameters of the dynamic model, all signals of the model itself can also be included in the model as inputs. This is possible if the inputs of the real physical system can also be measured directly or calculated based on measurements and, for example, the derivative(s) of the output(s) can additionally be derived, for example by numerical differentiation, a DT1-Filter, or by an observer. In this way, a model error term E(k) could be defined in one of the equations of the model that describes the current deviation between the model and the real physical system at the current operating point and is calculated as the output signal E(k) of the estimator mentioned above. A filtered version of this model error, E(k), referred to as, for example, E_{Fild}(k), could then be used as an additional input for a transformed model. The model may thus be tracked according to reality and derating may be further improved.

The invention analogously relates to a method for controlling/regulating an electrical device thermally coupled to a cooling system, comprising: sensing at least one temperature of a coolant incoming to and/or outgoing from the electrical device and/or a temperature of the electrical device, determining at least one electrical target variable of the electrical device from a dynamic model based on the temperature sensed at the temperature input, which is required to adjust a desired path of the temperature change rate and/or a desired temperature profile of the coolant or the device using a control unit, from at least one sensed temperature and one variable measured/calculated based on at least one characteristic variable and signals that take the current operating conditions of the electrical device into consideration, and outputting the at least one determined electrical target variable at a control signal output for activating the electrical device.

In an advantageous embodiment, the at least one determined electrical target variable is only reduced when a magnitude calculated from the temperate input or inputs exceeds a predetermined threshold.

In one advantageous embodiment, the method further comprises maintaining the temperature of the coolant at a predetermined maximum temperature by controlling the electrical device.

In one advantageous embodiment, the method further comprises single or multiple tracking and/or calibration processes of at least one simulated state variable and/or at least one simulated output variable to match measured output variables of the device to be cooled by incremental adjustment of at least one function element of the dynamic model by at least one model error correction term.

### BRIEF DESCRIPTION OF THE DRAWINGS

Further measures for improving the invention are described in greater detail hereinafter, together with the description of the preferred exemplary embodiments of the invention, with reference to the figures.

### EXEMPLARY EMBODIMENTS

Shown are:

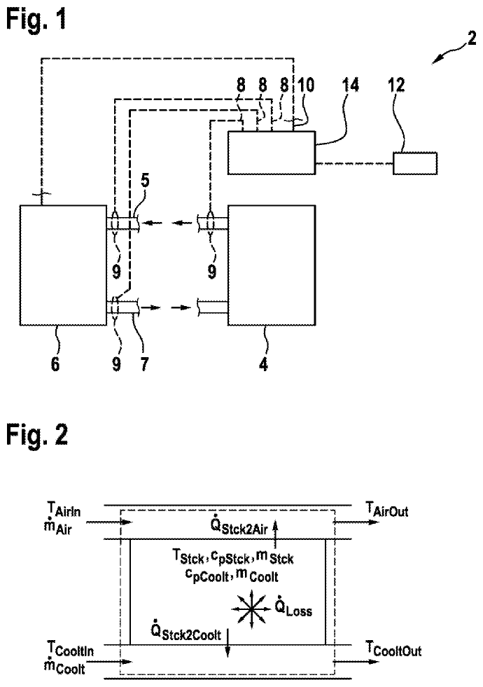

FIG. 1 a schematic representation of the system with cooling system and device to be cooled,

FIG. 2 a schematic diagram of a thermal model of a fuel cell,

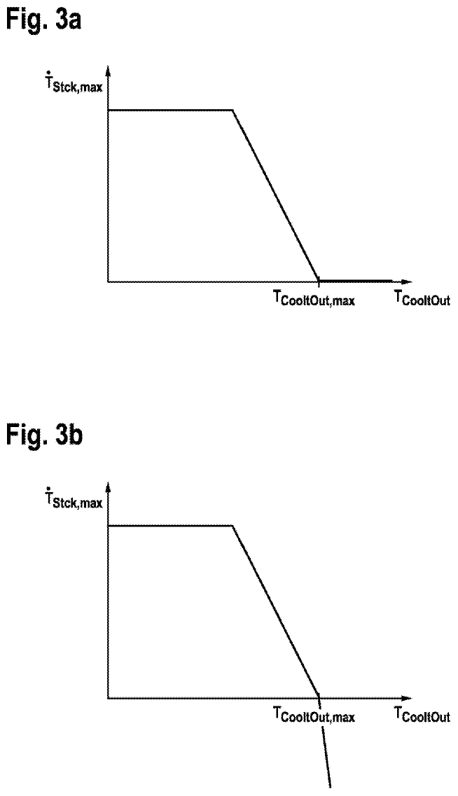

FIGS. 3a and 3b two diagrams with different exemplary profiles of a maximum allowable temperature change rate \dot{T}_{Stck,max} of the stack depending on the sensed coolant outlet temperature T_{CooltOut} of the fuel cell stack.

### DETAILED DESCRIPTION

FIG. 1 shows a simplified illustration of a system 2 intended to control/regulate an electrical device 6 thermally coupled to a cooling system 4. The device 6 comprises a coolant inlet 5 and a coolant outlet 7. The cooling system 4 delivers coolant into the coolant inlet 5 where it absorbs heat and exits the coolant outlet 7 to flow back into the cooling system 4 from there. Details of the cooling system 4 are not shown for the sake of clarity.

The system 2 comprises a control unit 14 having at least one temperature input 8 connected to at least one temperature sensor 9. The at least one temperature sensor 9 is disposed at the coolant inlet 5 and/or the coolant outlet 7 and is capable of sensing a temperature of the coolant incoming into and/or outgoing from the electrical device 6. Further temperature sensors may be disposed in the cooling system 4, for example, at the coolant outlet of a heat delivery device connected to a temperature input 8. However, a temperature sensor may also be disposed on the device connected to a temperature input 8. The control unit 14 further comprises a control signal output 10 and is coupled to a memory unit 12, which is configured to store and output at least one characteristic variable of the electrical device 6.

The control unit 14 is configured to determine at least one electrical target variable of the electrical device 6 from a temperature sensed at at least one temperature input 8 and a dynamic model based on the at least one characteristic variable and signals of measured/calculated variables that take the current operating conditions of the electrical device into consideration, which is required to adjust a desired path of the temperature change rate and/or a desired temperature profile of the coolant or the device 6. The control unit 14 is also configured to output the at least one determined electrical target variable at the control signal output 10 for activating the electrical device 6.

In the following, two approaches conceivable for this purpose, which are slightly different from one another, will be explained in more detail on the basis of the example of a fuel cell as an electrical device 6. The control unit 14 may be implemented in the fuel cell control unit (FCCU).

FIG. 2 shows a thermal model of a fuel cell stack that is a first-order model. It is comprised of a dynamic model of the fuel cell stack itself and a stationary model of the air and coolant therein. The model assumes that the temperature T_{CooltOut} of the coolant exiting the fuel cell stack is equal to the temperature T_{Stck} of the stack itself. This assumption is sufficiently justified by detailed experiments on the test bench and the control power achieved.

It is contemplated to model the fuel cell stack as an electrical equivalent in the form of a voltage source having an internal resistance. The output voltage U_{Stck} of the fuel cell stack deviates from the open-circuit voltage U_{OC} of the fuel cell stack, wherein the voltage drop is caused by the internal resistance of the voltage source. The electrical losses can therefore be calculated as the product of the voltage drop and fuel cell stack current I_{Stck} and are dissipated as heating power \dot{Q}_{Loss} in the fuel cell stack:

\dot{Q}_{Loss}=(U_{OC}−U_{Stck})·I_{Stck} (Eq. 1)

If \dot{m}_{Air} refers to the mass air flow through the fuel cell stack, h_{AirIn}(T_{AirIn}) or h_{AirOut}(T_{AirOut}) refers to the specific enthalpy of air at the inlet or outlet of the fuel cell stack and T_{AirIn}/T_{AirOut} refers to the air temperature at the inlet or outlet, the differential enthalpy flow Δ\dot{H}_{Air} between the air at the inlet and the outlet is:

Δ\dot{H}_{Air}=\dot{m}_{Air}·(h_{AirIn}(T_{AirIn})−h_{AirOut}(T_{AirOut})) (Eq. 2)

The variable \dot{Q}_{Stck2Air} designates the heating power from the fuel cell stack to the air in the fuel cell stack, so that the steady state power balance for the air in the fuel cell stack is determined as follows:

0=\dot{Q}_{Stck2Air}+Δ\dot{H}_{Air} (Eq. 3)

With the variables \dot{m}_{Coolt} as a mass coolant flow through the fuel cell stack, h_{CooltIn}(T_{CooltIn}) and h_{CooltOut}(T_{CooltOut}) as the specific enthalpy of the coolant at the inlet and outlet of the fuel cell stack as well as T_{CooltIn} or T_{CooltOut} for coolant temperature at the inlet or outlet, the differential enthalpy flow is Δ\dot{H}_{Coolt} between the coolant at the inlet and outlet:

Δ\dot{H}_{Coolt}=\dot{m}_{Coolt}·(h_{CooltIn}(T_{CooltIn})−h_{CooltOut}(T_{CooltOut})) ((Eq. 4).

With \dot{Q}_{Stck2Coolt} as the heating power from the fuel cell stack to the coolant in the fuel cell stack, the steady state power balance for the coolant in the fuel cell stack is:

0=\dot{Q}_{Stck2Coolt}+Δ\dot{H}_{Coolt} (Eq. 5)

The dynamic thermal model of the fuel cell stack, the heat capacity of which is formed by the material of the fuel cell stack and the coolant in the fuel cell stack, may be defined by a first order, ordinary differential equation. In this respect, m_{Stck} refers to the effective, thermodynamically active mass of the fuel cell stack; c_{pStck} refers to the specific heat capacity of the effective mass; m_{Coolt} refers to the coolant mass in the fuel cell stack; c_{pCoolt} refers to the specific heat capacity of the coolant; and \dot{T}_{Stck} refers to the first time derivation of temperature, i.e., the rate of change of temperature, of the fuel cell stack:

(c_{pStck}·m_{Stck}+c_{pCoolt}·m_{Coolt})·\dot{T}_{Stck}=\dot{Q}_{Loss}−\dot{Q}_{Stck2Air}−\dot{Q}_{Stck2Coolt} (Eq. 6)

This results in the following for \dot{Q}_{Loss}:

$${\dot{Q}}_{Loss} = ( {c}_{pStck} \cdot {m}_{Stck} + {c}_{pCoolt} \cdot {m}_{Coolt} ) \cdot {\dot{T}}_{Stck} - {\dot{m}}_{Air} \cdot ( {h}_{AirIn} ( {T}_{AirIn} ) - {h}_{AirOut} ( {T}_{AirOut} ) ) - {\dot{m}}_{Coolt} \cdot ( {h}_{CooltIn} ( {T}_{CooltIn} ) - {h}_{CooltOut} ( {T}_{CooltOut} ) ) \qquad ( Eq . 7 )$$

For I_{Stck}, Eq. 1 then yields:

$${I}_{Stck} = \frac{{\dot{Q}}_{Loss}}{( {U}_{OC} - {U}_{Stck} )} \qquad ( Eq . 8 )$$

By inserting the term from Eq. 7 in Eq. 8, I_{Stck} is used as a function of the model parameters, which can also be referred to as characteristic variables, i.e. c_{pStck}, m_{Stck}, etc., of the mass currents, i.e. \dot{m}_{Air}, \dot{m}_{Coolt}, of the voltages, i.e. U_{OC}, U_{Stck}, of the temperatures, i.e. T_{AirIn}, T_{AirOut}, T_{CooltIn}, T_{CooltOut} and the first temporal derivative of the temperature, i.e. the temperature rate of change, of the fuel cell stack \dot{T}_{Stck} determined as:

$${I}_{Stck} = \frac{1}{( {U}_{OC} - {U}_{Stck} )} \cdot ( ( {c}_{pStck} \cdot {m}_{Stck} + {c}_{pCoolt} \cdot {m}_{Coolt} ) \cdot {\dot{T}}_{Stck} - {\dot{m}}_{Air} \cdot ( {h}_{AirIn} ( {T}_{AirIn} ) - {h}_{AirOut} ( {T}_{AirOut} ) ) - {\dot{m}}_{Coolt} \cdot ( {h}_{CooltIn} ( {T}_{CooltIn} ) - {h}_{CooltOut} ( {T}_{CooltOut} ) ) ) \qquad ( Eq . 9 )$$

It should be noted again that, in the following model, it is assumed that the temperature T_{CooltOut} of the coolant exiting the fuel cell stack, i.e. the coolant outlet temperature T_{CooltOut}, is equal to the temperature T_{Stck} of the stack itself. Thus, the rate of change in temperature of the stack \dot{T}_{Stck} is also equal to the temperature rate of change \dot{T}_{CooltOut} of the coolant exiting the fuel cell stack. That is to say, in Eq. 9, T_{Stck}=T_{CooltOut} and _{Eq}.=\dot{T}_{CooltOut} can be used. This model assumption is advantageous if the temperature T_{Stck} of the stack and/or the temperature change rate \dot{T}_{Stck} of the stack is not detected.

This establishes a correlation between the power supplied by the fuel cell stack as an electrical device 6 and a temperature change, which is necessary for control and regulation of the device 6. Two approaches for using this are shown.

FIGS. 3a and 3b show two exemplary profiles of a maximum allowable temperature rate of change, \dot{T}_{Stck,max} of the stack depending on the sensed coolant outlet temperature T_{CooltOut} of the fuel stack. In this first derating approach of the invention, it is proposed to specify the maximum allowable temperature rate of change \dot{T}_{Component,max} of the cooled and controlled component as a function f( ) of at least one measured coolant temperature in the cooling circuit, e.g. \dot{T}_{Component,max}=f(T_{CooltOut}), oder \dot{T}_{Component,max}=f(T_{CooltIn}), oder \dot{T}_{Component,max}=f(T_{CooltIn},T_{CooltOut}), etc.

In the following section, this will again be explained in more detail based on the exemplary presented dynamic physical model of the cooled and controlled fuel cell stack derived in connection with FIG. 2. In Eq. 9, I_{Stck} was used as a function of the model parameters, i.e. c_{pStck}, m_{Stck}, etc., of the mass flows, i.e. \dot{m}_{Air}, \dot{m}_{Coolt}, of the voltages, i.e. U_{OC}, U_{Stck}, of the temperatures, i.e. T_{AirIn}, T_{AirOut}, T_{CooltIn}, T_{CooltOut}, and the first temporal derivative \dot{T}_{Stck} of the temperature (i.e., the temperature rate of change) of the fuel cell stack. During controlled operation of the fuel cell stack, i.e. the electrical device 6 to be cooled, the mass flows, i.e., \dot{m}_{Air}, \dot{m}_{Coolt}, voltages, i.e., U_{OC}, U_{Stck}, and temperatures, i.e., T_{AirIn}, T_{AirOut}, T_{CooltIn}, T_{CooltOut} could be calculated or measured. These signals are thus available as inputs for the dynamic model. Thus, the only remaining unknown and therefore freely selectable variable on the left side of equation 9 is \dot{T}_{Stck}. By stating a maximum allowable temperature change rate, \dot{T}_{Stck},max of the cooled and controlled fuel cell stack, the maximum permissible current I_{Stck,max}, which would result in this maximum allowable temperature change rate, \dot{T}_{Stck},max, can be calculated from equation 9.

In order to ensure that the reduction of the electrical current or the electrical power (i.e. the derating) is carried out evenly, \dot{T}_{Stck,max} could be defined as \dot{T}_{Stck,max}=f(T_{CooltOut}) with a curve similar to that shown in FIG. 3a or 3b. Compared to the function shown in FIG. 3a, the function shown in FIG. 3b together with equation 9 not only requires that, in the event that the coolant temperature T_{CooltOut,max} at the outlet of the fuel cell stack is already hotter than T_{CooltOut,max} the maximum allowable current I_{Stck,max} only has to lead not to a further increasing but to a decreasing fuel cell stack temperature T_{Stck}.

The functions in FIGS. 3a and 3b can easily be made able to be calibrated in any manner to meet desired power reduction needs by using a characteristic curve or map with well-defined interpolation behavior.

A second derating approach differs from the approach described above in that trajectory planning is performed based on the model variable T_{CooltOut}. In the exemplary case of a first-order model, such as that defined by equation 9, a trajectory generator is used to specify T_{CooltOut} and its first temporal derivative \dot{T}_{CooltOut} (i.e., the temperature rate of change). The trajectory generator could be realized as a filter element, for example a PT1 filter.

In the following section, T_{CooltOut,d} and \dot{T}_{CooltOut,d} denote the corresponding variables calculated by the trajectory generator, i.e. T_{CooltOut}=T_{CooltOut,d} and \dot{T}_{Stck}=\dot{T}_{CooltOut}=\dot{T}_{CooltOut,d} is used in FIG. 9, which allows the maximum allowable current I_{Stck,max} and/or a setpoint for the current to be calculated. In the event that a PT1 filter is used as a trajectory generator to determine the desired variables T_{CooltOut,d} and \dot{T}_{CooltOut,d}, the equations of the trajectory generator are:

$${Q}_{1} = {e}^{- \frac{Δ T}{{T}_{PT 1}}} \qquad ( Eq . 10 )$$

$$y ( k ) = ( 1 - {Q}_{1} ) \cdot u ( k ) + {Q}_{1} \cdot y ( k - 1 ) \qquad ( Eq . 11 )$$

$${T}_{PT 1} \cdot \dot{y} ( k ) + y ( k ) = u ( k ) \qquad ( Eq . 12 )$$

In equation 10, an auxiliary variable Q₁ is defined based on the scan time ΔT and a filter time constant of the PT1 filter T_{PT1}. This auxiliary variable Q1 is then inserted into the equation of the time-discrete PT1 filter (equation 11). In equation 12, the time-continuous equation of the PT1 filter is given. In equations 11 and 12, the variable k is the current time step, the variable u is the input of the PT1 filter, the variable y is the output of the PT1 filter, and the variable \dot{y} is the first time derivative of the output of the PT1 filter.

In equations 10 to 12, u(k) corresponds to the coolant temperature setpoint TCooltOut,Sp(k) at the coolant outlet, y(k) corresponds to the desired coolant temperature TCooltOut,d(k) at the coolant outlet, and (k) corresponds to the first time derivative (i.e., the temperature change rate) of the desired coolant temperature at the coolant outlet \dot{T}CooltOut,d(k).

For example, a maximum allowable current may now be calculated by setting T_{CooltOut,Sp}(k) to a (high) temperature threshold that should not be exceeded. In this way, an early initiation of a current reduction (or power reduction) and an overshoot of the temperature of the coolant or electrical device is avoided or reduced. A maximum allowable current may now also be calculated, for example, by setting T_{CooltOut,Sp}(k) to a low, or lower, value than before, as soon as a variable calculated from the or the temperate inputs exceeds a predetermined limit, for example. The above-mentioned approaches may also be combined or performed in an alternating fashion. In both cases, T_{CooltOut,d}(k) and \dot{T}_{CooltOut,d}(k) are calculated via equations 10 to 12 based on T_{CooltOut,Sp}(k). In this way, the maximum allowable current I_{Stck,max} results as follows:

$${I}_{Stck , max} = \frac{1}{( {U}_{OC} - {U}_{Stck} )} \cdot ( ( {c}_{pStck} \cdot {m}_{Stck} + {c}_{pCoolt} \cdot {m}_{Coolt} ) \cdot {\dot{T}}_{CooltOut , d} - {\dot{m}}_{Air} \cdot ( {h}_{AirIn} ( {T}_{AirIn} ) - {h}_{AirOut} ( {T}_{AirOut} ) ) - {\dot{m}}_{Coolt} \cdot ( {h}_{CooltIn} ( {T}_{CooltIn} ) - {h}_{CooltOut} ( {T}_{CooltOut , d} ) ) ) \qquad ( Eq . 13 )$$

Since the desired electrical variable is the target current, the target current is limited to the maximum allowable current I_{Stck,max} calculated via equation 13.

In equation 13, the calculated or measured variables are used for the remaining signals, i.e. the mass flows \dot{m}_{Air} and \dot{m}_{Coolt}, the voltages U_{OC}, U_{Stck} and the temperatures T_{AirIn}, T_{AirOut}, T_{CooltIn}.

Two examples of a representative system variable or calculated variable are listed below, which, when exceeding a predetermined limit, can be used as triggers to set the target value of the temperature, the size u(k) in equations 10 to 12, to a low, or lower, value than before, which then leads to the maximum allowable current I_{Stck,max} being reduced even further and thus to the temperature of the coolant and/or the stack dropping:

In a preferred embodiment, a representative temperature in which measured temperatures are included could be calculated as a representative system variable or calculated variable, respectively. For example, this representative temperature T_{Rep} could be determined via linear interpolation between the measured coolant inlet temperature T_{CooltInMeasd} and the measured coolant outlet temperature T_{CooltOutMeasd} as follows:

T_{Rep}=T_{CooltInMeasd}·(1−xᵢₙₜₑᵣₚₒₗₐₜᵢₒₙ)+T_{CooltOutMeasd}−xᵢₙₜₑᵣₚₒₗₐₜᵢₒₙ (Eq. 14)

Wherein, in Eq. 14 the variable for linear interpolation xᵢₙₜₑᵣₚₒₗₐₜᵢₒₙ is selected between 0 and 1.

In a preferred embodiment, the positive temperature difference between the measured coolant outlet temperature T_{CooltOutMeasd} and a temperature threshold T_{TooHot}, indicating that the coolant or electrical device is already too hot, could be integrated as a representative system variable or calculated variable, starting at a certain time, numerically as follows:

S(k+1)=S(k)+max(0,(T_{CooltOutMeasd}(k)−T_{TooHot}(k)))·ΔT (Eq. 15)

Wherein the calculated integral variable S(k) is set to 0 in the time step k=0, i.e. S(k=0)=0 and ΔT denotes the scan time. Further, a reset of the calculated integral variable S(k) may occur, for example, when the temperature of the coolant or electrical device is cold enough once again.

This second approach, i.e., the approach with the trajectory planning, can also be combined with the first approach, i.e., the approach in which the maximum allowable temperature change rate, \dot{T}_{Stck,max} of the stack is made dependent on at least one sensed temperature of the coolant or of the stack, or alternatively tracked for this purpose.

1. A system (2) for controlling/regulating an electrical device (6) thermally coupled to a cooling system (4), the system comprising:
a temperature input (8) for sensing a temperature of a coolant incoming into and/or outgoing from the electrical device (6) and/or a temperature of the electrical device (6),
a control signal output (10),
a storage unit (12) configured to store and output a characteristic variable of the electrical device (6), and
a control unit (14) connected to the temperature input (8), the storage unit (12), and the control signal output (10),
wherein the control unit (14) is configured to determine an electrical target variable of the electrical device (6) from the temperature sensed at the temperature input (8) and a dynamic model based on the characteristic variable and signals of measured/calculated variables that take the current operating conditions of the electrical device (6) into consideration, which is required to adjust a desired path of the temperature change rate and/or a desired temperature profile of the coolant or the device (6), and
wherein the control unit (14) is configured to output the determined electrical target variable at the control signal output (10) for activating the electrical device (6).

2. The system (2) according to claim 1,
wherein the control unit (14) is configured to reduce the desired temperature rate of change and/or the desired temperature of the coolant or device (6) when a variable calculated from the temperate inputs exceeds a predetermined limit.

3. The system (2) according to claim 1,
wherein the control unit (14) is configured to adjust a desired maximum curve of the temperature change rate and/or a desired maximum temperature profile of the coolant or the device (6) by limiting the electrical target variable to a maximum value.

4. The system (2) according to claim 1,
wherein the control unit (14) is configured to adjust a desired minimum curve of the temperature change rate and/or a desired minimum temperature profile of the coolant or the device (6) by limiting the target electrical variable to a minimum value.

5. The system (2) according to claim 1,
wherein the control unit (14) is configured to maintain the temperature of the coolant and/or the device (6) at a predetermined maximum temperature by controlling the electrical device (6).

6. The system (2) according to claim 1,
wherein the control unit (14) is configured to track and/or calibrate a simulated state variable and/or a simulated output variable by incremental adjustment of a function member of the dynamic model by a model error correction term to measured output variables of the device (6) to be cooled once or multiple times.

7. A method of controlling/regulating an electrical device (6) thermally coupled to a cooling system (4), comprising:
sensing a temperature of a coolant incoming into and/or flowing out of the electrical device (6) and/or a temperature of the electrical device (6),
determining an electrical target variable of the electrical device (6) required to adjust a desired path of the temperature change rate and/or a desired temperature profile of the coolant or the device (6) using a control unit (14), from the sensed temperature and a dynamic model based on a characteristic variable and signals of measured/calculated variables, considering the current operating conditions of the electrical device (6), and
outputting the determined electrical target variable at a control signal output (10) to activate the electrical device (6).

8. The method according to claim 7,
wherein the determined electrical target variable is only reduced if a variable calculated from the temperate inputs exceeds a predetermined limit.

9. The method according to claim 7,
wherein the determined electrical target variable is configured to adjust a desired maximum curve of the temperature change rate and/or a desired maximum temperature profile of the coolant or the device (6) by limiting the electrical target variable to a maximum value.

10. The method according to claim 7,
wherein the determined electrical target variable is configured to adjust a desired minimum curve of the temperature change rate and/or a desired minimum temperature profile of the coolant or the device (6) by limiting the electrical target variable to a minimum value.

11. The method according to claim 7,
further comprising maintaining the temperature of the coolant and/or the device (6) to a predetermined maximum temperature by activating the electrical device (6).

12. The method according to claim 7,
further comprising tracking and/or calibrating a simulated state variable and/or a simulated output variable to measured output variables of the device (6) to be cooled by incremental adjustment of a function element of the dynamic model by a model error correction term once or several times.
